(19) United States
(12) Patent Application Publication
(10) Pub. No.: US 2010/0037847 A1
(43) Pub. Date: Feb. 18, 2010

(54) Internal combustion engine comprising several combustion chambers

(76) Inventors: Jochen Häfner, Lorch (DE); Dieter Nowak, Weilheim (DE)

Correspondence Address: KLAUS J. BACH, 4407 TWIN OAKS DRIVE, MURRYSVILLE, PA, 15668, US

(21) Appl. No.: 12/583,011

(22) Filed: Aug. 12, 2009

Related U.S. Application Data
(63) Continuation-in-part of application No. PCT/EP2008/000799, filed on Feb. 1, 2008.

(30) Foreign Application Priority Data
Feb. 16, 2007 (DE) 10 2007 007 638.1

(51) Int. Cl. F02F 11/00

(52) U.S. Cl. 123/193.3

(57) ABSTRACT

In an internal combustion engine having several combustion chambers formed in in-line cylinders wherein an air/fuel mixture can be combusted and which include a common cylinder head, with discharge passages formed within the cylinder head and extending to a common confluence zone in communication with a discharge manifold, the common confluence zone is delimited on a first side (A) by at least one cylinder head wall and a separate shell element on a second side mounted to the outside of the cylinder head, the shell element being curved funnel-like for conducting the exhaust gas away from the engine.

This is a Continuation-in-Part application of pending International Patent application PCT/EP2008/000799 filed Feb. 1, 2008 and claiming the priority of German patent application 10 2007 007 638.1 filed Feb. 16, 2007.

### BACKGROUND OF THE INVENTION

The invention relates to an internal combustion engine with several combustion chambers formed in cylinders, in which an air/fuel mixture can be reacted in a combustion reaction and wherein the combustion chambers are delimited by a joint cylinder head, and an exhaust gas discharge passage is associated with each combustion chamber, and several discharge passages extend into a joint confluence zone in the region of a discharge manifold.

DE 101 41 534 A1 discloses a cylinder head for an internal combustion engine having several cylinders, in which several discharge ducts extend from discharge openings of the combustion chambers. The discharge ducts join to form a confluence zone, which is essentially completely integrated into the cylinder head and is delimited by cooling water passages arranged above and below the discharge duct. A mounting surface for a catalytic converter is provided at a flange of the cylinder head, which catalytic converter is bolted directly to the cylinder head. Such a configuration results in a particularly extensive heat exchange between the cooling water in the cooling water passages and the exhaust gas in the confluence zone, however, an elaborate and complicated cylinder head design results, which can be realized only in an expensive manner.

It is the object of the present invention to provide an exhaust gas manifold with especially simple means, whose heat transfer behavior is also advantageous.

### SUMMARY OF THE INVENTION

In an internal combustion engine having several combustion chambers formed in in-line cylinders wherein an air/fuel mixture can be combusted and which include a common cylinder head, with discharge passages formed within the cylinder head and extending to a common confluence zone in communication with a discharge manifold, the common confluence zone is delimited on a first side (A) by at least one cylinder head wall and a separate shell element on a second side mounted to the outside of the cylinder head, the shell element being curved funnel-like for conducting the exhaust gas away from the engine.

On the first side of the joint confluence zone several discharge passages are preferably provided, which are formed as components of the cylinder head especially by casting methods and extend to the common confluence zone. For forming the common confluence zone, a tub-shaped recess is provided on the outer side of the cylinder head, which is delimited by several wall structures of the cylinder head preferably cast in one piece. The tub-shaped recess is closed and sealed to the outside by means of a shell element, so that a space is formed between the recess on the side of the cylinder head and the shell element, in which several exhaust gas flows can be joined and diverted. This space is thus formed partially Within the cylinder head and partially outside the cylinder head.

In one arrangement of the invention, a mounting flange for the sealed mounting of the shell element at the cylinder head on the one hand, and a discharge opening with a pipe flange for mounting an exhaust gas pipe or an exhaust gas cleaning unit are provided, wherein the mounting flange and the pipe flange have different dimensions. The essentially annular mounting flange defines a planar or curved separation plane between the cylinder head and the shell element, wherein the separation plane engages through the confluence zone or the space and divides it geometrically. The pipe flange is designed smaller than the mounting flange with regard to a geometric dimension, especially with regard to a maximum transverse extension and/or its diameter and/or the cross section which can accommodate the exhaust gas flow.

The invention will become more readily apparent from the following description of a preferred, embodiment of the invention while referring to the enclosed drawings.

### BRIEF DESCRIPTION OF THE DRAWINGS

FIG. 1 is a sectional view of a cylinder head of an internal combustion engine according to the invention with an exhaust gas manifold shown in a schematic manner and

FIG. 2: a perspective view of the cylinder head.

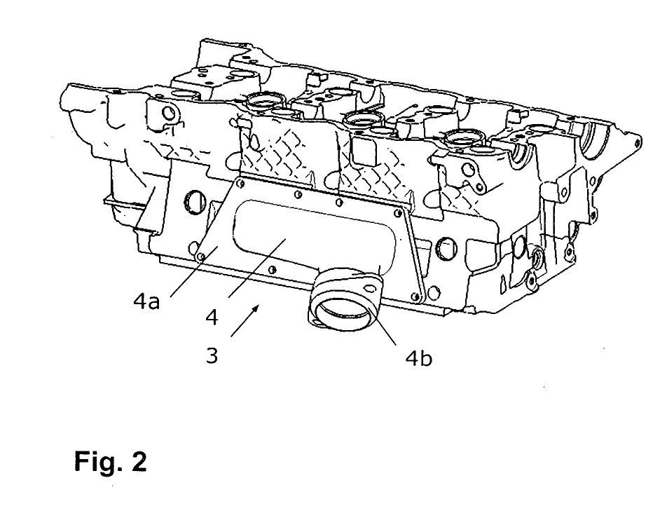

### DESCRIPTION OF A PARTICULAR EMBODIMENT

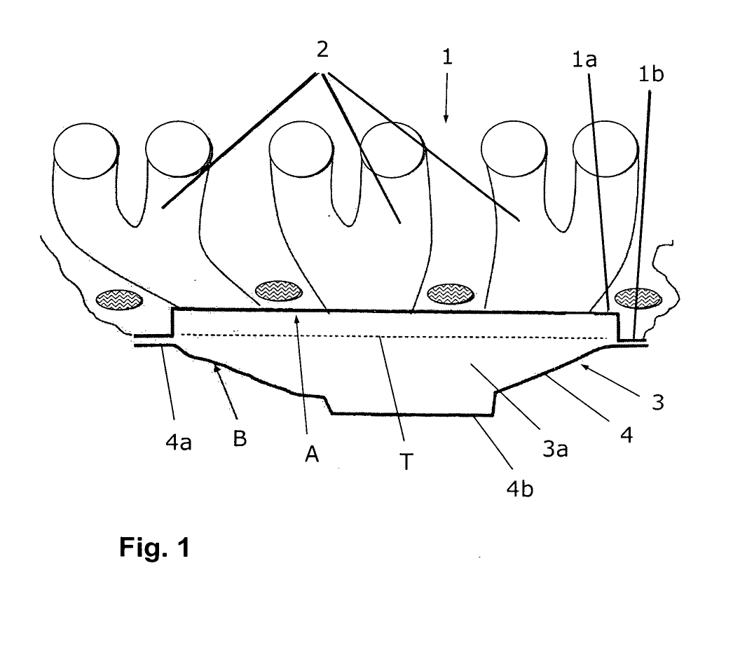

FIG. 1 shows a horizontal section of a cylinder head bank of an internal combustion engine according to the invention, which has six cylinders in two separate cylinder banks arranged in a V-shaped manner, in which an air/fuel mixture can be combusted while generating pressure and heat. The combustion can be carried out according to the diesel method, the Otto method, or a similar combustion method. Each bank has three cylinders including three combustion chambers which are delimited by a common cylinder head 1, preferably manufactured as an single piece by a casting method. Two discharge passages 2 formed in the cylinder head 1 are associated with each combustion chamber, and can be closed by exhaust valves, not shown, in a manner known per se. The discharge passages 2 are designed in a curved manner in the direction toward the exhaust gas duct downstream in a known manner and are positioned close to a cylinder head screw connection and/or close to lubricating oil return bores.

The described six discharge passages 2 of a cylinder bank are associated with a common confluence zone 3a in the region of the discharge manifold 3, in which the exhaust gas flows guided through the discharge passages 2 are joined. The joint confluence zone 3a is limited by a wall 1a of the cylinder head 1 on a first side A of the cylinder head. The wall 1a of the cylinder head is essentially tub-shaped or cup-shaped and is surrounded by an annular mounting surface 1b. The discharge passages 2 are formed within the cylinder head wall 1a, and are arranged in a recessed manner starting from a non-annular separation surface to be defined along the annular mounting surface 1b.

The confluence zone 3a is delimited by a separate shell element 4 mounted to the cylinder head side wall on a second side B, which delimits the confluence zone 3a towards the outside and forms a component of the discharge manifold 3. The shell element 4 is preferably constructed of a temperature-resistant metal sheet, especially sheet steel, or it is a metal casting part and is curved like a funnel and/or a tub in at least some sections. Its simple form enables an especially simple and economic production of the shell element. In a modified embodiment, the shell element comprises a circumferential annular groove which engages the cylinder head in the region of the tub-shaped mounting surface. In a further modified embodiment, the shell element is formed in a double-walled manner. In again a further modified embodiment, the shell element is comparatively small, whereby the sealing between the cylinder head and the shell element is facilitated.

The shell element 4 has a mounting flange 4a for the mounting by means of screws. The mounting flange is designed abutting the mounting surface 1b. Thus, one or several preferably annular sealing elements can be used between the mounting surface 1b and the mounting flange 4a, which are disposed in a separation plane T.

A pipe flange 4b is provided at the shell element 4 spaced from the separation plane T and spaced from the cylinder head 1, the flow cross section of which is different with regard to essential geometric dimensions in comparison with the mounting flange 4a. The pipe flange has preferably an essentially annular flow cross section, so that a cylindrical pipe element can be directly mounted thereto. The pipe element may be a part of an exhaust gas pipe line and/or of an exhaust gas cleaning unit (catalytic converter, filter or the like).

The tub-shaped recess is closed towards the outside by means of the shell element 4, so that a space is formed between the recess on the side of the cylinder head 1 and the shell element 4, in which several exhaust gas flows are joined, diverted and conducted to a downstream exhaust gas system. This space is thus formed partially within the cylinder head (side A) and partially outside the cylinder head (side B), whereby an especially simple and economically realizable assembly of two approximately vertically divided halves is obtained. On the other hand, by means of constructive measures, e.g. the dimensioning of the form and depth of the shell element and the corresponding recess on the side of the cylinder head 1, a certain desired heat transfer behavior can be obtained. For example, during a cold start of the internal combustion engine, heat transfer to the cooling water, can be reduced in comparison with an embodiment wherein the exhaust gas manifold fully integrated in the cylinder head, so that a faster heating of downstream connected exhaust gas cleaning units is achieved.

What is claimed is:

1. An internal combustion engine with several combustion chambers formed in inline cylinders, in which an air/fuel mixture can be exothermically combusted, the cylinders including a common cylinder head (1), at least one exhaust gas discharge passage (2) provided in the cylinder head for each combustion chamber and the at least one discharge passage (2) of each combustion chamber extending into a common confluence zone (3a) formed in the region of a discharge manifold (3), said confluence zone (3a) being delimited by a cylinder head wall (1a) on a first side (A), and a separate shell element (4) on a second side (B) mounted to the cylinder head, wherein the shell element (4) is mounted on the outside of the cylinder head and is curved in a funnel and/or a tub-like manner in at least some sections in order to collect and conduct the exhaust gas flow out of the cylinder head, the discharge passages (2) being formed in the cylinder head (1) and openings of the discharge passages (2) are formed within the wall (1a) of the cylinder head, which delimits a common confluence zone (3a) on the first side (A) of the cylinder head.

2. The internal combustion engine according to claim 1, wherein a mounting flange (4a) for the sealed mounting of the shell element (4) at the cylinder head (1) and a discharge opening with a pipe flange (4b) for mounting an exhaust pipe or an exhaust gas cleaning device are provided at the shell element (4), wherein the mounting flange (4a) and pipe flange (4b) have different dimensions.

3. The internal combustion engine according to claim 1, wherein the shell element (4) consists of one of a temperature-resistant sheet metal and a metal casting part.

4. The internal combustion engine according to claim 1, wherein the shell element (4) is a double-walled structure.
